(19) United States
(12) Patent Application Publication
(10) Pub. No.: US 2005/0170940 A1
(43) Pub. Date: Aug. 4, 2005

(54) Container

(76) Inventor: Ake Rosen, Rydeback (SE)

Correspondence Address: BIRCH STEWART KOLASCH & BIRCH, PO BOX 747, FALLS CHURCH, VA, 22040-0747, US

(21) Appl. No.: 10/486,884

(22) PCT Filed: Aug. 28, 2002
(86) PCT No.: PCT/SE02/01532

(30) Foreign Application Priority Data
Aug. 29, 2001 (SE) 0102866-1

(51) Int. Cl. B31B 1/00

(52) U.S. Cl. 493/51

(57) ABSTRACT

A container for liquid contents, comprising a compartment (60) which is defined by flexible walls (58, 59) and whose volume is dependent on the relative position of the walls (58, 59), the walls (58, 59) having rim portions which engage each other and along which the walls (58, 59) are interconnected in a common connecting portion (32). The container is characterised in that said walls (58, 59) are formed in one piece, which is folded to form said walls (58, 59) with rim portions engaging each other. The present invention also concerns a method and a device for producing such a container, as well as a container material and a device for producing such a container material.

### FIELD OF THE INVENTION

The present invention relates generally to containers of a collapsible type and, more specifically, a container according to the preamble to claim 1, a method and a device for producing containers according to the preambles to claim 6 and claim 11, respectively, a container material according to the preamble to claim 19, and a device for producing a container material according to the preamble to claim 22.

### BACKGROUND ART

Containers of the type described by way of introduction are usually related to as collapsible containers, which are advantageous since the compartment defined by the walls of the container decreases its volume as liquid contents are being poured out of the container. As a result, the degree at which the contents are exposed to air is reduced, which has a positive effect on the shelf life of the contents. The containers can also be produced at an advantageously low cost and can be adapted to aseptic filling.

Containers of the above type are known from, for example, WO99/4155.

The containers described therein are produced by joining three material webs, which are then sealed in connecting portions. Each connecting portion has a form which essentially corresponds to a completed container. Subsequently a web of succeeding containers is punched from the joined material webs. Each container released from the web forms a container which before filling is in a flat, empty and sealed state. Each container has two opposite side walls and a bottom wall, each wall being obtained from a separate material web.

The thus produced containers have a number of advantages. It is particularly preferable to produce the containers of a container material containing a filler of mineral material and a binder of polyolefin. This results in a container of a collapsible type, which in spite of a small material thickness has the requisite rigidity to provide a container which is environment-friendly as well as user-friendly.

A problem associated with this type of container concerns the actual production method. In fact the containers usually have a decorative print on their outside, and this print is usually applied to the material webs from which said containers will later be produced. It will be appreciated that the different material webs must be joined with great accuracy in order to ensure an alignment of patterns as required. This also applies to the accuracy with which the material webs are sealed to each other to form said connecting portions. The connecting portion in fact forms the outer contour of the container, and it is therefore important for the decorative print to be centred within this contour.

Furthermore for sealing the material webs to each other in said connecting portions, a sealing tool must be moved down towards the joined material webs. During the actual sealing process, the material web must be stopped, which causes intermittent operation that is unfavourably time-consuming.

There is thus a need for a container of this type, which can be produced at a higher production rate and without necessitating alignment of patterns.

### SUMMARY OF THE INVENTION

In view of that stated above, an object of the present invention is to provide a new and improved container of the type described by way of introduction as well as a method and a device for producing a corresponding container blank. The container blank should be suited especially for a continuous production process without great demands for alignment of patterns.

One more object is to provide an improved web-shaped container material and a device for producing the same. The web-shaped container material should be intended for subsequent production of containers of the type described above.

According to the present invention, these objects, as well as other objects that are evident from the following description, will be achieved by a container having the features stated in claim 1, a method and a device for producing containers having the features stated in claim 6 and claim 11, respectively, a container material having the features stated in claim 19 and a device for producing a container material having the features stated in claim 22. Preferred embodiments of the container are evident from claims 2-5, preferred embodiments of the method are evident from claims 7-10, preferred embodiments of the device for producing containers are evident from claims 12-18, preferred embodiments of the container material are evident from claims 20-21, and preferred embodiments of the device for producing a container material are evident from claims 23-26.

More specifically, according to the present invention a container for liquid contents is provided, comprising a compartment which is defined by flexible walls and whose volume is dependent on the relative position of the walls, the walls having rim portions which engage each other and along which the walls are interconnected in a common connecting portion, said container being characterised in that said walls are formed in one piece, which is folded to form said walls with rim portions engaging each other.

This results in a container of a collapsible type which is extremely simple to produce. By the container being made of one piece, which is folded to form the walls of the container, it will be significantly easier to obtain good alignment of patterns when connecting the different walls of the container along their rim portions in said connecting portion.

According to a preferred embodiment of the inventive container, said piece is folded to form two opposite side walls and an intermediate bottom wall. This results in a container which in its filled state forms a stable bottom.

According to another preferred embodiment, the container is in an empty, flat and sealed state before filling. This results in a container which is not very bulky and which can be sterilised and, with retained sterility, be distributed to a user. If the container comprises a bottom wall, this is folded in two in the flat state of the container.

The container is preferably made of a material comprising a core layer with a filler of mineral material and a binder of polyolefin material.

According to the present invention, a method is also provided for producing containers, which each comprise a compartment which is defined by flexible walls and whose volume is dependent on the relative position of the walls, said method being characterised by the steps of converting a web-shaped container material into a longitudinally folded web with at least one fold along a long side of the folded web, and subsequently joining opposite surfaces of the web along succeeding connecting portions, each connecting portion forming a curve which has a starting point and a terminal point along said at least one fold and has an extent which essentially corresponds to the form of a completed container.

This results in a method, which allows rational production of containers of the type in question. By the container being made of a web-shaped container material, which is converted into a longitudinally folded web, the need of combining a plurality of different material webs is eliminated. This means that it is possible to achieve great accuracy in the alignment of patterns.

Preferably, the web-shaped container material is converted into a web which is longitudinally folded essentially in the form of a W and which has two folds extending along said long side, in order to form in the web two opposite, essentially flat lateral portions and an intermediate portion which is folded in two and connects the two lateral portions, the container obtaining a side wall from the respective lateral portions and a bottom wall from the intermediate portion.

According to a preferred embodiment of the inventive method, the step of converting the web-shaped container material into a longitudinally folded web is preceded by the step of applying succeeding adhesive prints to an inside-forming surface of the container material, said adhesive prints each having complementarily designed portions which are caused to abut against each other when the web-shaped container material is converted into a longitudinally folded web. Moreover the step of connecting opposite surfaces of the web along connecting portions advantageously comprises heating the web to make the complementarily designed portions of each adhesive print adhere to each other, said adhesive prints forming said connecting portions. This ensures that an extremely good alignment of patterns is achieved. It will also be possible to produce containers in a continuous process.

According to yet another preferred embodiment, two succeeding connecting portions adjoin each other and the containers are released from the web along said connecting portions, in such manner that two succeeding containers are interconnected to form a web of containers.

Further according to the present invention, a device is provided for producing containers, which each have a compartment which is defined by flexible walls and whose volume is dependent on the relative position of the walls, said device being characterised by a folding station for converting a web-shaped container material into a longitudinally folded web with at least one fold along a long side of the folded web and a connecting station for connecting surfaces of the web, which engage each other, along succeeding connecting portions, which each form a curve which has a starting point and a terminal point along said at least one fold and has an extent which essentially corresponds to the form of a completed container. As a result, a device is provided, which allows production of containers of a collapsible type from a web-shaped container material, which significantly facilitates the accuracy in the alignment of patterns between the walls of each container.

Preferably the device comprises a punching station for releasing the completed containers from said web along said connecting portions, the connecting station advantageously being adapted to arrange the succeeding connecting portions adjacent to each other, and said punching station being adapted to release the containers in such manner that the succeeding containers are interconnected to form a web of containers.

According to a preferred embodiment, the folding station of the device is adapted to convert the web-shaped container material into a web which is longitudinally folded in the form of a W and has two folds along its one long side in order to form in said web two opposite, essentially flat lateral portions and an intermediate portion which is folded in two and connects the lateral portions, each completed container obtaining a side wall from the respective lateral portions and a bottom wall from said intermediate portion.

According to one more preferred embodiment, the device comprises a printing station for applying succeeding adhesive prints to an inside-forming surface of the container material, said folding station being arranged for such conversion of the web-shaped container material that the complementarily designed portions of each adhesive print engage each other in the longitudinally folded web. The connecting station advantageously comprises heating means for heating the web to such a temperature that said complementarily designed portions of each adhesive print adhere to each other and form said connecting portions. This allows production of containers in a continuous and, thus, time-efficient and economically advantageous process with accurate alignment of patterns. It will be appreciated that the printing station can be physically separated from the rest of the device.

According to a further preferred embodiment, the connecting stations comprises a wheel having a large diameter and an endless belt which, together with said wheel, forms an elongate nip extending along part of the circumference of the wheel, the folded web being insertable into said elongate nip to provide said succeeding connecting portions.

According to one more preferred embodiment, the connecting station comprises a plurality of rolls which between them form nips, into which the folded web is insertable to provide said succeeding connecting portions.

Furthermore according to the present invention a web-shaped container material is provided, which is characterised by succeeding adhesive prints, which are applied to an inside-forming surface of the material and each have complementarily designed portions which are engageable with each other by folding of the container material in the longitudinal direction. As a result, a container material is achieved which allows continuous production of containers with accurate alignment of patterns.

Preferably, each adhesive print comprises a thermosetting adhesive.

According to a preferred embodiment, the web-shaped container material is made of a material containing a filler of mineral material and a binder of polyolefin material.

Finally, according to the present invention, a device is provided for producing a web-shaped container material, said device being characterised by a first printing station for applying succeeding adhesive prints to an inside-forming surface of a material web, said adhesive prints each having complementarily designed portions, which are engageable with each other by folding of the material web in the longitudinal direction.

According to a preferred embodiment, the first printing station of the device is arranged for application of adhesive prints comprising a thermosetting adhesive.

According to yet another preferred embodiment, the device further comprises a second printing station for applying succeeding decorative prints to an outside-forming surface of the material web.

The second printing station is preferably intended for UV flexoprinting and advantageously comprises cold UV lamps.

Preferred embodiments of the present invention will now be described by way of example and with reference to the accompanying drawings.

### BRIEF DESCRIPTION OF THE DRAWINGS

FIG. 1 is a top plan view of an inventive container material.

FIG. 2 is a schematic side view of an inventive device for producing the container material in FIG. 1.

FIG. 3 is a schematic perspective view of an inventive device for producing a web of container blanks.

FIG. 4 is a perspective view of a broken-away part of a web-shaped container material, dashed lines indicating the way in which a folding station of the device shown in FIG. 3 is adapted to fold the container material.

FIG. 5 is a perspective view of the container material shown in FIG. 4 in its ready-folded state.

FIG. 6 is a side view of part of a web of containers produced in the device shown in FIG. 3.

FIG. 7 is a cross-sectional view along line VI-VI in FIG. 6.

FIGS. 8 and 9 are perspective views from above and from below of an inventive container.

### DESCRIPTION OF EMBODIMENTS

### Container Material

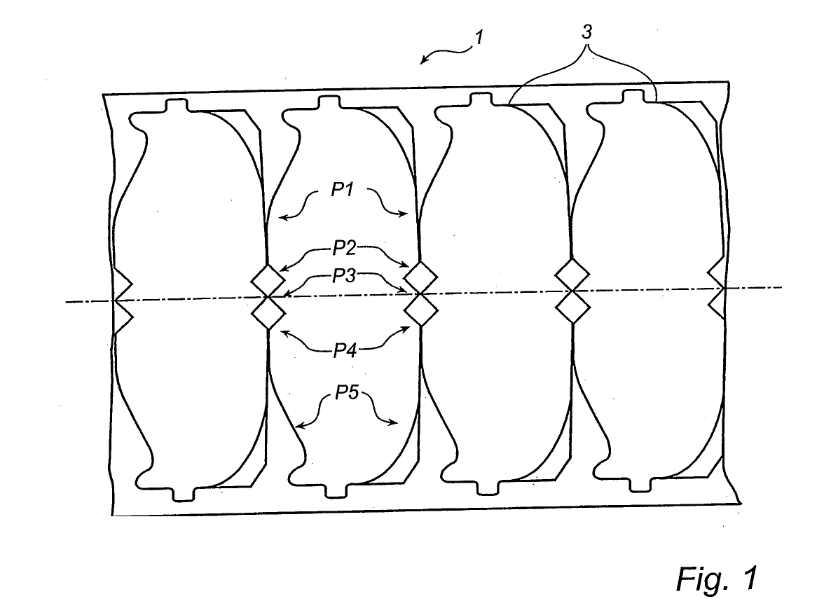

FIG. 1, to which reference is made, illustrates a broken-away part of a web-shaped container material 1 according to a preferred embodiment of the present invention.

The web-shaped container material 1 consists of a film material which preferably is a laminate containing a core layer with a filler of mineral material and a binder of polyolefin material such as polyethylene or polypropylene. Preferred fillers are chalk, talc and/or mica.

The container material 1 has an inside-forming surface 2, to which a plurality of succeeding adhesive prints 3 are applied which each preferably comprise a thermosetting adhesive in the form of a hot melt having a melting point which is lower than that of the film material.

Each adhesive print 3 forms a closed curve and comprises a number of mutually complementarily designed portions P which are engageable with each other by folding of the container material 1 in the longitudinal direction. According to the embodiment shown, each adhesive print 1 comprises more specifically a first upper portion P1, which connects to a first lower portion P2, which in turn connects to a bottom portion P3. The bottom portion P3 further connects to a second lower portion P4 which finally connects to a second upper portion P5. By conveniently folding the container material 1 in the longitudinal direction, as will be described below in more detail, the upper portions P1 and P5 will thus be made to engage each other while the lower portions P2 and P4 will each be made to engage a separate part of the bottom portion P3.

As shown in FIG. 1, the adhesive prints 3 are arranged so as to adjoin each other.

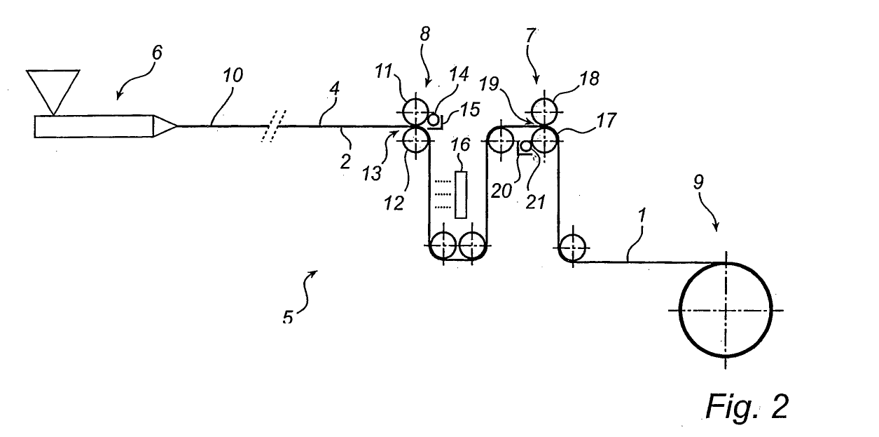

Decorative prints (not shown) can be applied to an outside-forming surface of the container material, which is opposite to said inside-forming surface 2 and which is shown at 4 in FIG. 2. It is ensured that these prints are applied within the scope of said adhesive prints 3.

### Device For Producing Container Material

FIG. 2, to which reference is now made, illustrates schematically a preferred embodiment of an inventive device 5 for producing the web-shaped container material 1 described with reference to FIG. 1.

The device comprises an extruder unit 6, a first 7 and a second 8 printing station and a winding station 9.

The extruder unit 6 is adapted to produce a web-shaped film material 10 in a conventional fashion, and therefore said extruder unit 6 will not be described in more detail. The film material 10 preferably consists of a laminate containing a core layer with a filler of mineral material and a binder of polyolefin material.

The second printing station 8 is adapted to apply a decorative print to the outside-forming surface 4 of the web-shaped film material 10 and is preferably intended for so-called UV flexoprinting. The second printing station 8 therefore comprises in the shown embodiment an assembly having a cylinder 11 which is provided with a printing block and which, together with a counter cylinder 12, forms a nip 13. Moreover, an inking cylinder 14 abuts against the cylinder 11 provided with a printing block, said inking cylinder 14 being to some extent immersed in a vat 15 containing ink and, thus, transferring ink to the cylinder 11 provided with a printing block.

In UV flexoprinting, use is made of an ink which is of a type that dries only when exposed to UV light, and therefore the second printing station 8 comprises a set of UV lamps 16.

The accuracy, with which the decorative print is applied to the film material 10, must be extremely great. It is therefore preferable for said set of UV lamps 10 to be so-called cold UV lamps. This ensures that heat is not transferred to the film material in connection with the UV light exposure, thereby eliminating the appearance of dimensional changes of the film material 10 caused by heat.

However, it will appreciated that the second printing station 8 can also be arranged for other printing methods.

It will also be appreciated that the inventive device 5 for producing a web-shaped container material 1 may also comprise a plurality of printing stations of the type described above if a multicoloured decorative print is desired.

The first printing station 7 is in the shown embodiment positioned downstream of the second printing station 8 and is adapted to apply succeeding adhesive prints 3 to an inside-forming surface 2 of the web-shaped film material 10. The first printing station 7 comprises, to this end, a corresponding assembly having a cylinder 17 which is provided with a printing block and which, together with a counter cylinder 18, forms a nip 19. A roll 21 immersed in a vat 20 abuts against the cylinder 17 provided with a printing block for transferring an adhesive thereto. The adhesive prints 3 applied to the film material 10 advantageously comprise a thermosetting adhesive.

When producing the inventive container material 1, the web-shaped film material 10 produced in the extruder unit is passed to the nip 13 of the second printing station 8, at which a decorative print is applied to an outside-forming surface 4 of the film material 10 via the cylinder 11 provided with a printing block. It will be appreciated that the film material 10 passed to said second printing station need not necessarily be supplied by an extruder unit 6. Thus, the film material 10 can also be supplied, for instance, in rolls.

The decorative print on the outside-forming surface 4 of the film material 10 is then exposed to UV light from the set of UV lamps 16, after which the film material 10 via a number of deflecting rollers is passed on to the nip 19 of the first printing station 7. Here, succeeding adhesive prints 3 are applied to the inside-forming surface 2 of the film material 10.

As a result, a web-shaped container material 1 has been provided, which in the shown embodiment of the inventive device 5 is wound up at said winding station 9 after the adhesive prints 3 have been treated in a suitable manner by drying or the like to allow said winding up.

### Device For Producing Containers

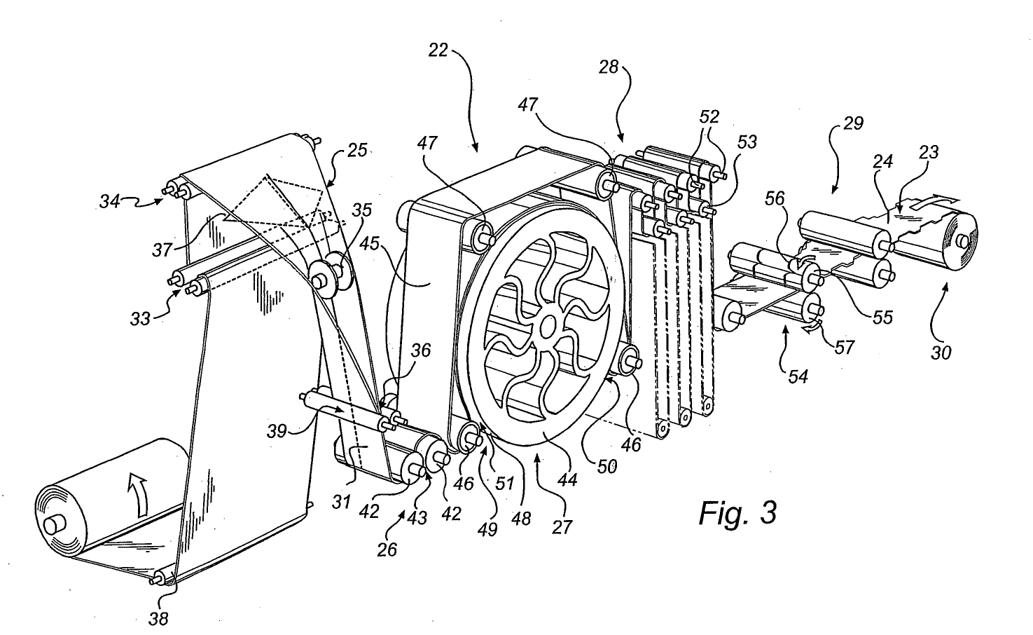

FIG. 3, to which reference is now made, illustrates a preferred embodiment of an inventive device 22 for producing a web 23 of containers 24. Each container 24 released from the web 23 forms a container which before filling is in a flat, empty and sealed state. The container 24 is of the type having a compartment which is defined by flexible walls and whose volume is dependent on the relative position of the walls.

The inventive device 22 comprises according to the shown embodiment a folding station 25, a preheating station 26, a connecting station 27, an accumulating station 28, a punching station 29 and a winding station 30.

A web-shaped container material 1 of the type which has been described above with reference to FIG. 1 and which in the embodiment shown is supplied in rolls, is passed to said folding station 25, at which the container material 1 is converted into a longitudinally folded web 31. The folding station 25 is constructed in such manner that the web-shaped container material 1 is folded longitudinally in such manner that the complementarily designed portions P of the adhesive prints 3 on the inside-forming surface 2 of the container material 1 are made to engage each other as described above with reference to FIG. 1.

Subsequently the thus longitudinally folded web 31 is passed to the preheating station 26, at which the web 31 is preheated.

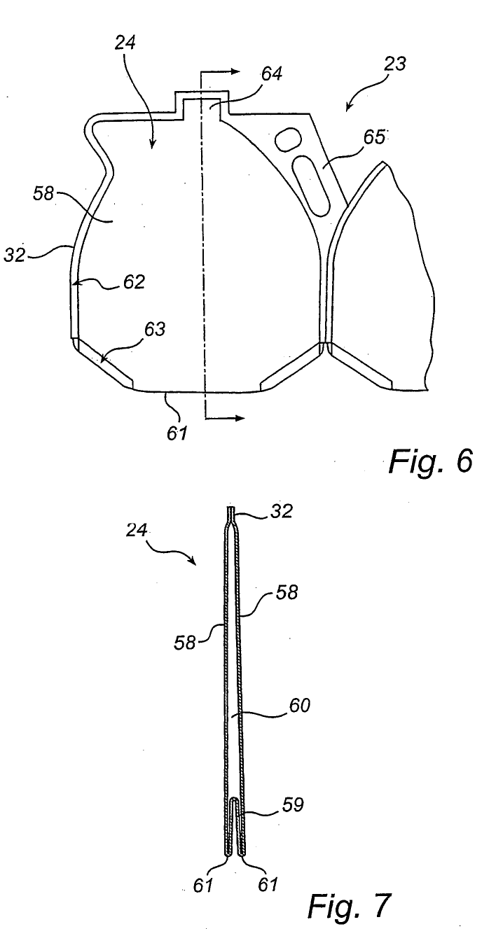

From the preheating station 26, the web 31 is passed to the connecting station 27, at which the complementarily designed portions P, engaging each other, of the respective adhesive prints 3 adhere to each other to form a connecting portion, which is shown at 32 in FIG. 6. This results in succeeding connecting portions 32 of the web 31, each connecting portion 32 having an extent which essentially corresponds to the form of a completed container 24. The adhesive prints 3 comprise, as mentioned above, preferably a thermosetting adhesive which sets under the action of heat. The connecting station 27 advantageously comprises heating means (not shown) for heating and retaining the web 31 to/at a temperature that is necessary for said adhesion. If the container material 1 is made of a film material containing a filler of mineral material and a binder of polyolefin material, it is possible, for instance, to use an adhesive that sets at a temperature in the range −80° C.-120° C. since the container material 1 remains unaffected at temperatures below 150° C.

Then the web 31, which thus carries succeeding connecting portions 32, is passed to the accumulating station 28 from which the web 31 continues to the punching station 29, at which a web 23 of containers 24 is released from the web 31. Said web 23 of containers 24 is then punched in such manner along said connecting portions 32 that two succeeding containers 24 are interconnected. The web 23 of containers 24 is finally wound up at the winding station 30.

The wound-up web 23 of containers 24 can then be used as container blanks at a filling machine, for instance of the type according to WO99/4155.

Thus each container 24 is empty, flat and sealed in its state before filling. As a result, sterilisation of the container 24 is allowed, and sterility can be maintained during further transport to a separately located filling machine thanks to the fact that the container 24 is sealed in its empty state.

The various stations of the inventive device 22 for producing containers 24 will now be described in more detail.

The folding station 25 comprises a first pair of deflecting rollers 33 and, arranged above the same, a second pair of deflecting rollers 34. On a level with said first pair of deflecting rollers 33, a guide wheel 35 is arranged, below which a nip-forming pair of rolls 36 is arranged, which is perpendicularly oriented in relation to said first 33 and second 34 pair of deflecting rollers. Moreover, a folding means 37 is arranged just below a second deflecting roller of the second pair of deflecting rollers 35.

For folding the web-shaped container material 1 in the longitudinal direction, this is passed via a separate deflecting roller 38 to and over a first deflecting roller of the first pair of deflecting rollers 33 and further on to and under a second deflecting roller of said pair 33. Then the container material 1 continues upwards to and over a first deflecting roller of the second pair of deflecting rollers 34 and on to and over the second deflecting roller of the same pair 34. From here the container material 1 is passed downwards to a nip 39 of the nip-forming pair of rolls 36. At the same time the material 1 is folded while the folding means 37 engages the material 1 to produce a web 31 which is longitudinally folded in the form of a W and which consequently has two folds 66 along one long side. It is thus a web 31 folded in the form of a W which is passed into said nip 39, the guide wheel 35 ensuring that the folding in the form of a W will be continuously uniform.

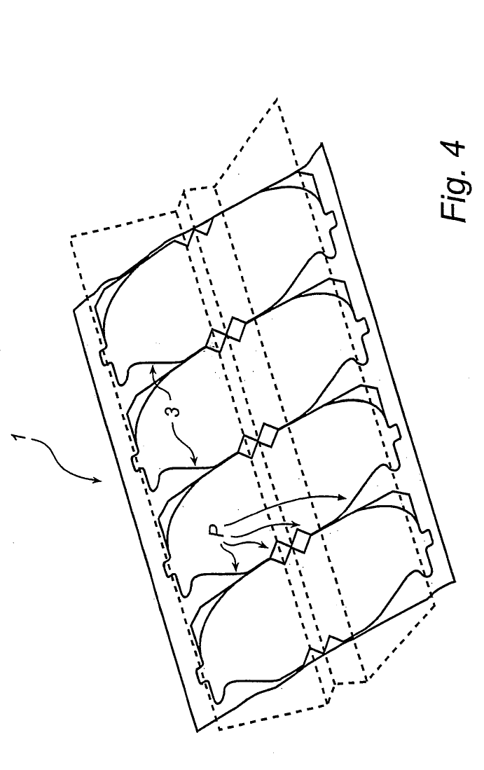

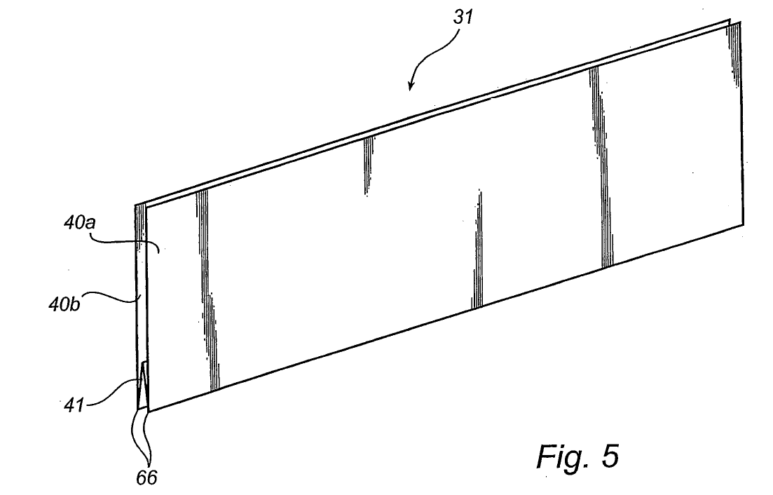

Said folding of the container material 1 to form a web 31 which is longitudinally folded in the form of a W is illustrated more clearly in FIGS. 4 and 5. FIG. 4 illustrates a broken-away part of the web-shaped container material 1, which on its inside-forming surface 2 carries a plurality of succeeding adhesive prints 3. The folding station 25 is thus arranged for folding the material 1 in the form of a W, which is indicated by dashed lines in the Figure, so as to form a web 31 with two opposite, essentially flat lateral portions 40a and 40b and an intermediate portion 41 folded in two which connects the two lateral portions 40a and 40b according to that shown in FIG. 5. The mutually complementarily designed portions P of the respective adhesive prints 3 will be made to engage each other as described above. Each lateral portion 40a; 40b will carry an upper portion P1; P5 and a lower portion P2; P4 of the respective adhesive prints 3 while the bottom portion P3 of the adhesive print 3 is carried by the intermediate portion 41.

According to the embodiment shown, the preheating station 26 comprises two heated cylinders 42 which between them form a nip 43 into which the web 31 folded in the form of a W is inserted.

According to the embodiment shown, the connecting station 27 comprises a rotatable wheel 44 having a large diameter and an endless belt 45 running over for rotatable deflecting rollers 46, 47. Two of the deflecting rollers 46 adjoin the circumferential surface 48 of the wheel 44 on one side 49, 50 each of the wheel 44. That part of the endless belt 45 which extends between these two deflecting rollers 46 forms, together with the circumferential surface 48 of the wheel 44, an elongate nip 51 which extends along a major part of the circumference of the wheel 44. By varying the position of the deflecting rollers 46, 47, it is possible to adjust the pressure at which the belt 45 abuts against the circumferential surface 48 of the wheel 44. The wheel 44 further comprises heating means (not shown) for heating to and retaining a temperature that is necessary for adhesion of the adhesive prints 3. To this end, the wheel 44 can comprise ducts which extend from the hub of the wheel 44, via its spokes out to its circumferential surface 48, in which ducts a hot heating medium, such as heated oil, can be circulated. However, other types of heating means are of course conceivable.

The web 31 folded in the form of a W is thus inserted into the elongate nip 51 at the first side 49 of the connecting station 27 facing the preheating station 26, in which elongate nip 51 the complementarily designed portions P of the adhesive prints 3 will, under the action of pressure and temperature, adhere to each other to form connection portions 32. Each connecting portion will, more specifically, form a curve which has a starting point and a terminal point along said fold 66 and has an extent which essentially corresponds to the form of the completed container. Thus, both the endless belt 45 and the wheel 44 are thus driven at such a speed that the relative speed between the web 31 folded in the form of a W and inserted into the elongate nip 51 and the circumferential surface 48 of the wheel 44 and the endless belt 45, respectively, is essentially zero. Then the web 31 will leave the nip 51 at the second side 50 of the connecting station 27. The extent of the elongate nip 51 ensures that each adhesive print 3 is retained at the necessary pressure and temperature for a time that is sufficient for the adhesive of each adhesive print 3 to set and, thus, cause said adhesion.

According to the embodiment shown, the accumulating station 28 comprises a first set of fixedly arranged upper roll means 52 and a second set of freely movable lower roll means 53. The web 31 is passed alternatingly over the upper 52 and the lower 53 roll means. On the occasions when the output from the accumulating station 28 falls or is interrupted, such as when changing the rolls of the winding station 30, the movable lower roll means 53 are allowed to move away from the upper roll means 52, whereby the accumulating capacity of the station 28 increases, which is indicated by dashed lines.

Finally, the punching station 29 comprises according to the embodiment shown a roll punch 54 having a first cylinder 55 carrying a cutting means 56 and a second cylinder 57 against which the cutting means 56 of the first cylinder 55 acts. The cutting means 56 has been given such a geometric appearance that a web 23 of interconnected containers 24 will be punched from the web 31. Of course, it will be ensured that said punching takes place along the connecting portions 32 of the web 31, which, as mentioned above, have an extent which essentially corresponds to the form of the completed containers 24. Thus the completed container 24 will have a side wall from the respective lateral portions 40a, 40b and a bottom wall from the intermediate portion 41 of the web 31 folded in the form of a W.

It will be appreciated that the inventive device 22 for producing a web 23 of containers 24 can be designed in other ways.

For instance, it is conceivable to fully omit the preheating station 26 or design it in some other fashion.

Moreover the connecting station 27 can be designed in other ways. For instance, it is possible to replace the wheel 44 having a large diameter and the endless belt 45 with a row of cylinders of the type that is found at the preheating station 26. To provide connecting portions 32 with sufficient strength, the complementarily designed portions P of the adhesive prints 3 must be made to engage each other under pressure and heating for a pre-determined period. In this context, it would be possible, by selecting a suitable type of adhesive print, nip print, and temperature to provide the desired connection by moving the web 31 through a single nip. To provide a more reliable connection it is possible to arrange a plurality of nips of the type that is found at the preheating station 26. However, in both cases it will be possible to omit the elongate nip 51.

### Container

FIGS. 6 and 7, to which reference is now made, illustrate a preferred embodiment of part of an inventive web 23 of containers 24 produced according to that described above with reference to FIGS. 3-5. Released from the web 23, each container 24 forms a container which before filling is in an empty, flat and sealed state.

The container 24 comprises a compartment 60 which is defined by flexible walls 58, 59 and whose volume is dependent on the relative position of the walls 58, 59.

More specifically, the walls 58, 59 of the container 24 comprise two opposite side walls 58 and a bottom wall 59, said walls 58, 59 being formed in one piece and delimited from each other by means of folds 61. The walls 58, 59 have rim portions which engage each other and along which the walls 58, 59 are connected in a common connecting portion 32. More specifically, the connecting portion 32 comprises an upper connecting portion 62, in which rim portions of the side walls 58 are interconnected, and a lower connecting portion 63, in which lower parts of the rim portions of the side walls 58 are connected with rim portions of the bottom wall 59.

The bottom wall 59, which separates the two side walls 58 from each other, is, in the flat state of the container 24, in a state folded in two, which is clearly to be seen in FIG. 7. The cross-section of the empty and flat container 24 as shown in FIG. 7 is shown with its side walls 58 slightly separated for improved clarity.

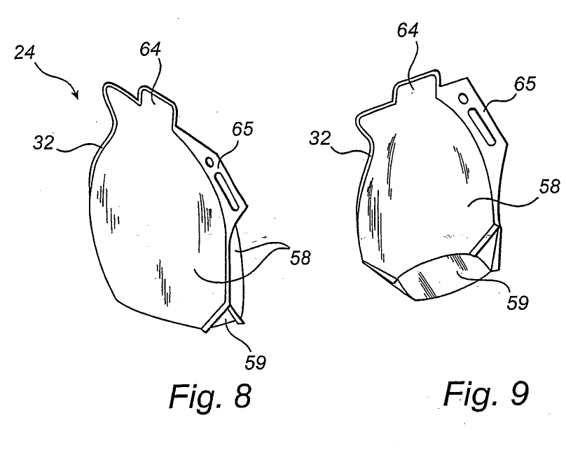

FIGS. 8-9, to which reference is now also made, illustrate the container 24 shown in FIGS. 6-7 in its filled and sealed state. Filling suitably takes place in such manner that a duct means 64 of the container 24 is opened by cutting or like operation, after which liquid contents are supplied to the compartment 60 defined by the walls 58, 59 of the container through said duct means 64. After the filling has been completed, the duct means 64 is sealed once more.

As is evident especially from FIG. 9, the bottom wall 59 folded in two is straightened out in connection with filling of the container 24 and thus forms a stable bottom of the container 24.

As is also evident from the Figures, the container 24 is preferably formed with a carrying means 65, which makes the container 24 more user-friendly. Of course, the adhesive prints 3 of the container material 1 are adjusted so that said carrying means 65 are formed in the connecting portion 32 of the container 24. The punching station 29 of the device 22 for producing containers is arranged for punching out said carrying means 65.

According to the present invention, a web-shaped container material 1 is thus provided, which is produced by means of a device 5 comprising a printing station 7 which is adapted to apply succeeding adhesive prints 3 to an inside-forming surface 2 of the material 1.

According to the present invention, a device 22 for producing a web 23 of containers 24 is also provided. Said container material 1 is converted into a longitudinally folded web 31, whereby complementarily designed portions 2 of each of said adhesive prints 3 are made to engage each other. These portions P of the adhesive print 3 which engage each other, are allowed to adhere to each other to form succeeding connecting portions 32, which form curves, which each have a starting point and a terminal point along said fold 66 and have an extent that essentially corresponds to the form of the completed container 24.

Preferably, the container material 1 is converted into a web 31 which is longitudinally folded in the form of a W, thus allowing production of containers 24 comprising two opposite side walls 58 which are interconnected via a bottom wall 59.

Finally, according to the present invention a container 24 is provided, comprising a compartment 60 which is defined by walls 58, 59 and whose volume is dependent on the relative position of the walls 58, 59. The walls 58, 59 are formed in one piece and have rim portions, along which the walls 58, 59 are interconnected in a common connection portion 32.

Thus, the present invention concerns a unique container 24 of a collapsible type which can be produced in a continuous process from a unique container material 1.

Since the container material 1 can have predefined adhesive prints 3, which by folding of the material 1 and subsequent heating form said connecting portions 32, the need for sealing tools is eliminated, which in intermittent operation engage the longitudinally folded web 31. Thus, the inventive containers 24 can be produced in a continuous process, which has an extremely positive effect on the speed at which the containers 24 can be produced.

The orientation of the connection portions 32 is dependent on the location of the adhesive prints 3, which means that it is possible to obtain a very accurate alignment of patterns.

The containers 24 are made from a single material web 31 which has been folded in a suitable fashion. Thus, the need of joining a plurality of separate material webs and, thus, also the associated problems regarding alignment of patterns have been eliminated.

It will be appreciated that the present invention is not restricted to the embodiments shown and that several modifications and variations are feasible. The scope of the present invention is thus defined exclusively by the appended claims.

1. A container for liquid contents, comprising flexible walls (58, 59) whose inner faces define a compartment (60) whose volume is dependent on the relative position of the walls (58, 59), the walls (58, 59) having rim portions which engage each other and along which the inner faces of the walls (58, 59) are interconnected in a common connecting portion (32), characterised in that said walls (58, 59) are formed in one piece, which is folded to form said walls (58, 59) with rim portions engaging each other.

2. A container as claimed in claim 1, in which said piece is folded to form two opposite side walls (58) and an intermediate bottom wall (59).

3. A container as claimed in claim 1 or 2, in which the container, before filling, is in an empty, flat and sealed state.

4. A container as claimed in claim 3 while referring to claim 2, in which said bottom wall (59) is folded in two in the empty, flat and sealed state of the container.

5. A container as claimed in claim 1, wherein said container is made of a material (1) comprising a core layer with a filler of mineral material and a binder of polyolefin material.

6. A method for producing containers (24), which each comprise a compartment (60) which is defined by flexible walls (58, 59) and whose volume is dependent on the relative position of the walls (58, 59), characterised by the steps of
converting a web-shaped container material (1) into a longitudinally folded web (31) with at least one fold (66) along a long side of the folded web (31), and
subsequently joining opposite surfaces of the web (31) along succeeding connecting portions (32),
each connecting portion (32) forming a curve which has a starting point and a terminal point along said at least one fold (66) and has an extent which essentially corresponds to the form of a completed container (24).

7. A method as claimed in claim 6, in which the web-shaped container material (1) is converted into a web (31) which is longitudinally folded essentially in the form of a W and which has two folds (66) extending along said long side, in order to form in the web (31) two opposite, essentially flat lateral portions (40a, 40b) and an intermediate portion (41) which is folded in two and connects the two lateral portions (40a, 40b), the container (24) obtaining a side wall (58) from the respective lateral portions (40a, 40b) and a bottom wall (59) from the intermediate portion (41).

8. A method as claimed in claim 6 or 7, in which the step of converting the web-shaped container material (1) into a longitudinally folded web (31) is preceded by the step of applying succeeding adhesive prints (3) to an inside-forming surface (2) of the container material (1), said adhesive prints (3) each having complementarily designed portions (P) which are caused to engage each other when the web-shaped container material (1) is converted into a longitudinally folded web (31).

9. A method as claimed in claim 8, in which the step of connecting opposite surfaces of the web (31) along connecting portions (32) comprises heating the web (31) to make the complementarily designed portions (P) of each adhesive print (3) adhere to each other, said adhesive prints (3) forming said connecting portions (32).

10. A method as claimed in claim 6, in which two succeeding connecting portions (32) adjoin each other and in which the containers (24) are released from the web (31) along said connecting portions (32), in such manner that two succeeding containers (24) are interconnected to form a web (23) of containers (24).

11. A device for producing containers (24), which each have a compartment (60) which is defined by flexible walls (58, 59) and whose volume is dependent on the relative position of the walls (58, 59), characterised by
a folding station (25) for converting a web-shaped container material (1) into a longitudinally folded web (31) with at least one fold along a long side of the folded web (31) and a connecting station (27) for connecting surfaces of the web (31), which engage each other, along succeeding connecting portions (32), which each form a curve which has a starting point and a terminal point along said at least one fold (66) and has an extent which essentially corresponds to the form of a completed container (24).

12. A device as claimed in claim 11, further comprising a punching station (29) for releasing the completed containers (24) from said web (31) along said connecting portions (32).

13. A device as claimed in claim 12, in which said connecting station (27) is adapted to arrange the succeeding connecting portions (32) adjacent to each other, and said punching station (29) is adapted to release the containers (24) in such manner that the succeeding containers (24) are interconnected to form a web (23) of containers (24).

14. A device as claimed in any one of claims 11-13, in which said folding station (25) is adapted to convert the web-shaped container material (1) into a web (31) which is longitudinally folded in the form of a W and has two folds along its one long side in order to form in said web (31) two opposite, essentially flat lateral portions (40a, 40b) and an intermediate portion (41) which is folded in two and connects the lateral portions (40a, 40b), each completed container (24) obtaining a side wall (28) from the respective lateral portions (40a, 40b) and a bottom wall (59) from said intermediate portion (41).

15. A device as claimed in claim 11, further comprising a printing station (7) for applying succeeding adhesive prints (3) to an inside-forming surface (2) of the container material (1), said folding station (25) being arranged for such conversion of the web-shaped container material (1) that the complementarily designed portions (P) of each adhesive print (3) engage each other in the longitudinally folded web (31).

16. A device as claimed in claim 15, in which the connection station (27) comprises heating means for heating the web (31) to such a temperature that said complementarily designed portions (P) of each adhesive print (3) adhere to each other and form said connecting portions (32).

17. A device as claimed in claim 11, in which the connecting station (27) comprises a wheel (44) having a large diameter and an endless belt (45) which, together with said wheel (44), forms an elongate nip (51) extending along part of the circumference of the wheel (44), the folded web (31) being insertable into said elongate nip (51) to provide said succeeding connecting portions (32).

18. A device as claimed in claim 11, in which the connecting station (27) comprises a plurality of rolls which between them form nips, in which the folded web (31) is insertable to provide said succeeding connecting portions (32).

19. A web-shaped container material, characterised by succeeding adhesive prints (1), which are applied to an inside-forming surface (2) of the material and each have complementarily designed portions (P) which are engageable with each other by folding of the container material in the longitudinal direction.

20. A web-shaped container material as claimed in claim 19, in which each adhesive print (3) comprises a thermosetting adhesive.

21. A web-shaped container material as claimed in claim 19 or 20, in which the container material is made of a material (10) containing a filler of mineral material and a binder of polyolefin material.

22. A device for producing a web-shaped container material (1), characterised by a first printing station (7) for applying succeeding adhesive prints (3) to an inside-forming surface (2) of a material web (10), said adhesive prints (3) each having complementarily designed portions (P), which are engageable with each other by folding of the material web (4) in the longitudinal direction.

23. A device as claimed in claim 22, in which the first printing station (7) is arranged for application of adhesive prints (3) comprising a thermosetting adhesive.

24. A device as claimed in claim 22 or 23, further comprising a second printing station (8) for application of succeeding decorative prints to an outside-forming surface (4) of the material web (10).

25. A device as claimed in claim 24, in which said second printing station (8) is intended for UV flexoprinting.

26. A device as claimed in claim 25, in which said second printing station (8) comprises cold UV lamps (16).
